(19) United States
(12) Patent Application Publication
(10) Pub. No.: US 2014/0003063 A1
(43) Pub. Date: Jan. 2, 2014

(54) Carton for Shipping, Storage, and Display of a Lamp

(71) Applicant: Bruce A. Monaghan, Parkland, FL (US)

(72) Inventor: Bruce A. Monaghan, Parkland, FL (US)

(73) Assignee: Design Solutions International Inc, Tamarac, FL (US)

(21) Appl. No.: 13/537,962

(22) Filed: Jun. 29, 2012

(51) Int. Cl. F21V 21/00; B65D 85/00; F21V 1/00

(52) U.S. Cl. 362/351; 362/382; 53/397

(57) ABSTRACT

A method and system is provided which a lamp packaging, shipping, and/or display device including a shell comprising a support column and base receptacle, a base support and a backplane support. The support column terminates above the lamp but allows access to the shade attachment area for fitting the lamp with various lamp shades without removing the lamp from the packaging. The support column also provides support for the lamp and for stacking of multiple units during shipment, storage, or display.

### CROSS-REFERENCE TO RELATED APPLICATIONS

Not Applicable

### BACKGROUND OF THE INVENTION

The present invention generally relates to a packaging for electric lamps. More particularly, the present invention relates to a packaging device for shipping, storage and display of electric lamps.

A variety of packaging cartons are available in the marketplace which are prepared from blanks made form cardboard, plastic or other suitably flexi-stiff material. Flexi-stiff materials are generally flexible enough for bending into place during the assembly, but stiff enough to retain their shape thereafter. The blanks are pre-dimensioned, pre-creased, and pre-cut into sections such that when the so-defined separated, folded and interconnected, the assembled product is suitable for shipping, storage and/or display of the article it was designed to contain.

Several versions of packaging cartons have been designed for lamps, both electric and other. Some are designed for containment of the lamp alone, others contain the lamp, shade, or other components. For example Humphrey U.S. Pat. No. 6,325,209 and RE 36565 are designed to ship, store, and display electric lamps and in some embodiments shades, utilizing a flexi-stiff carton, plastic molding, and/or foam molds. The display capability is limited to a viewing window of the exterior carton giving the viewer a sense of the general texture and color of the lamp.

In Bin US 2006/0285334 and US 2006/0283741 the cartons are designed for shipping, storage and display of a lamp with a collapsible lamp shade. In several embodiments the carton has an open display area allowing the viewer to see and or feel the lamp. These cartons have the added feature of displaying of a lamp shade graphic with the lamp by placing it in a hood or panel. This is an improvement over the previous art but is limited to a graphic of the lamp shade that accompanies the lamp. Further access to the area of shade attachment is obscured by the hood.

Other commonly available carton designs are the open front box, either a face of the box is removed for display or the box is divided diagonally to the base to allow for display. Neither of these designs allow for access to the area for shade attachment. Further the removal of a face of the box without a substitute support compromises the shipping and storage capabilities, as the resultant structure is not capable of multiple unit stacking without failure of the flexi-stiff materials.

### BRIEF SUMMARY OF THE INVENTION

One or more of the embodiments of the present invention provide a lamp packaging, shipping, and/or display device including a shell comprising a support column and base receptacle, a base support and a backplane support. The support column terminating above the lamp but allowing access to the shade attachment area for fitting the lamp with various lamp shades without removing the lamp from the packaging. The support column also providing support for the lamp and for stacking of multiple units.

### BRIEF DESCRIPTION OF THE DRAWINGS

FIG. 1 illustrates a lamp packaging, shipping, and displaying device according to an embodiment of the present invention. The lamp packaging, shipping, and displaying device includes a shell, a shade harp, and a lamp.

FIG. 2 illustrates a detailed view of the upper support, the lower support, and the shade harp assembled for installation into the shell.

FIG. 3 illustrates a detailed view of the base support.

FIG. 4 illustrates a front view of the shell of FIG. 1 with the lamp removed to show detail of the shell, the backplane support, and the base support.

FIG. 5 illustrates an embodiment of a lamp packaging, shipping, and displaying device with a lamp shade and shade harp installed on a lamp.

FIG. 6 illustrates multiple lamp packaging, shipping, and displaying devices and a packing flat to show the structural function of the device for shipping, storage, and display.

### DETAILED DESCRIPTION OF THE INVENTION

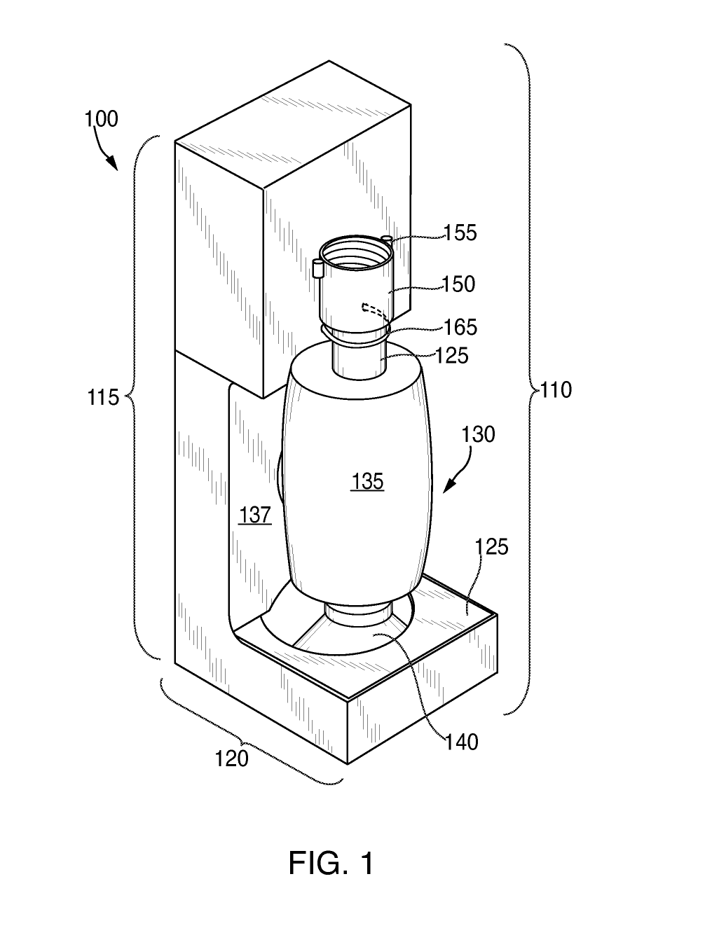

FIG. 1 illustrates a lamp packaging, shipping, and displaying device 100 according to an embodiment of the present invention. The lamp packaging, shipping, and displaying device 100 includes a shell 110, and a lamp 130. The shell includes a support column 115, a base receptacle 120 a backplane support 137, and a retention strap 165. The lamp 130 includes a shaft 135, a base 140, a light bulb socket 150, and a shade harp receiver 155.

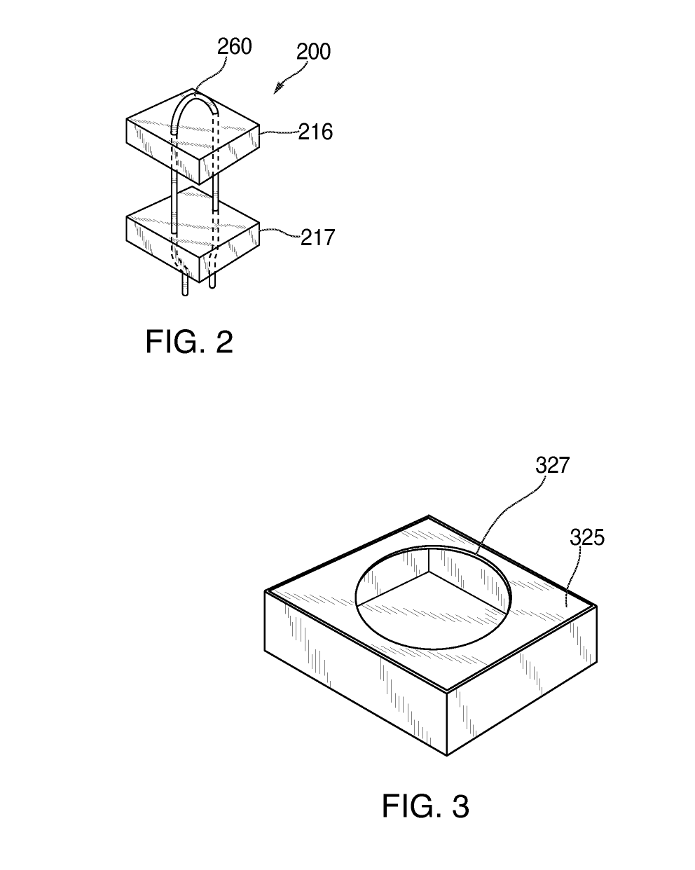

The shell 110 includes two subsections, the support column 115 and the base receptacle 120. The support column 115 is further categorized into the lower and upper sections. The support column contains an upper support 216 and lower support 217, depicted in FIG. 2. The base support 125 is positioned within the base receptacle 120. The base 140, of the lamp 130, is placed within the base support 125. The shaft 135 extends from the lamp base 140. The backplane support 137 extends from the base receptacle to the upper section of the support column 115. The light bulb socket 150 extends from the lamp shaft 125. The shade harp receiver 155 is mounted to the light bulb socket 150. The retention strap 165 connects through apertures in the support column 115 and around the light bulb socket 150.

In operation the shell 110 is constructed of cardboard, plastic, or other suitable flexi-stiff material. The shell 110 is pre-dimensioned, pre-creased, and pre-cut into the support column 115 and base receptacle 120, backplane support 137, and base support 125. The art of scoring cardboard and the like for folding into a packing shape is well known in the field, and it may be applied to the extent necessary to produce the device herein taught without prejudice hereto. In the preferred embodiment the support column 115 and base receptacle are made from a single piece of material. The base receptacle 120 forms a base with four side walls and an open top. The support column 115 lower section is formed of three side walls with an open top, bottom, and front face. These walls are shared with the upper section. The support column 115 upper section is formed of a top, four walls and a flap on the bottom edge of the front wall which is inserted into the backplane support and forms bottom wall. The backplane support 137 is formed of three side walls, two are inserted parallel to the support column side walls the third forms a front wall for the support column. The base support 130 is formed of a top, four sides walls, and an open bottom end.

The support column 115 is cut so that the lower section is removed allowing for a large diameter lamp shaft 135, and close proximity of the upper section to the light bulb socket 150 for retention. The backplane support 137 fits into the opening left by the cutout of the lower section of the support column 115 providing support for the front face, extending from the top of the base support 130 into the support column 115 upper section. The backplane support 137 may have a cutout to allow for the penetration of lamp shaft 135 and a second cutout for the penetration of the lamp base 140. The base support 125 is placed within the base receptacle 120. The base 140, of the lamp 130, is set within the base support 125. The lamp shaft is parallel with the backplane support 137. The lamp 130 is retained in the shell 110 by a retention strap 165. The retention strap 165 penetrates the support column 115 and the backplane support 137 by apertures and secures the lamp 130 around the light bulb socket. The retention strap may be twine, wire, plastic or other suitable material.

The shell 110 and lamp 130 when completely assembled leave ample room for a display shade harp to be attached and for a lamp shade to be attached. This allows for the attachment of various shapes and sizes of lamp shade without the removal of the lamp 130 form the shell 110. Further the support column 115 and backplane 137 are situated behind the lamp 130 leaving an unobstructed view of the lamp with shade.

A display bulb may also be provided to screw into the light bulb socket 150. With the display bulb in place clip type lamp shades may be affixed to the bulb to allow for the viewing of multiple lamp shades without removal of the lamp 130 from the shell 110.

The support column 115 may have a cutout for a hand grip for ease of picking up the unit.

FIG. 2 illustrates a shape harp retention assembly 200 consisting of an upper support 216, the lower support 217, and the shade harp 260 The upper support 116 and lower support 117 are made of the same flexi-stiff material as the shell of FIG. 1 and are formed a base and four walls with an open end. The shade harp 260 is retained by penetrating the apertures in the upper support 216 and the lower support 217. The dimensions of the upper support 216 and lower support 217 are predetermined based off the dimensions of the shell, such as 110 of FIG. 1. The spacing and size of the apertures are determined by the size and shape of shade harp to be used with the product.

The shade harp assembly 200 is inserted into the support column for storage of the shade harp and to provide support to the support column. The upper support 216 and lower support 217 also act as spacers between the back plane and support shaft to ensure each is maintained in position and to increase radial support of the support column.

FIG. 3 illustrates a detailed view of the base support 325. The base support 325 provides axial support for the lamp base, such as 140 of FIG. 1, to prevent movement or damage during shipping or storage. A base cutout 327 is provided in the base support 325 in pre-determined dimension for the intended product. The base cutout is preferred to be slightly larger than the lamp base dimension to allow for ease of assemble while restricting movement.

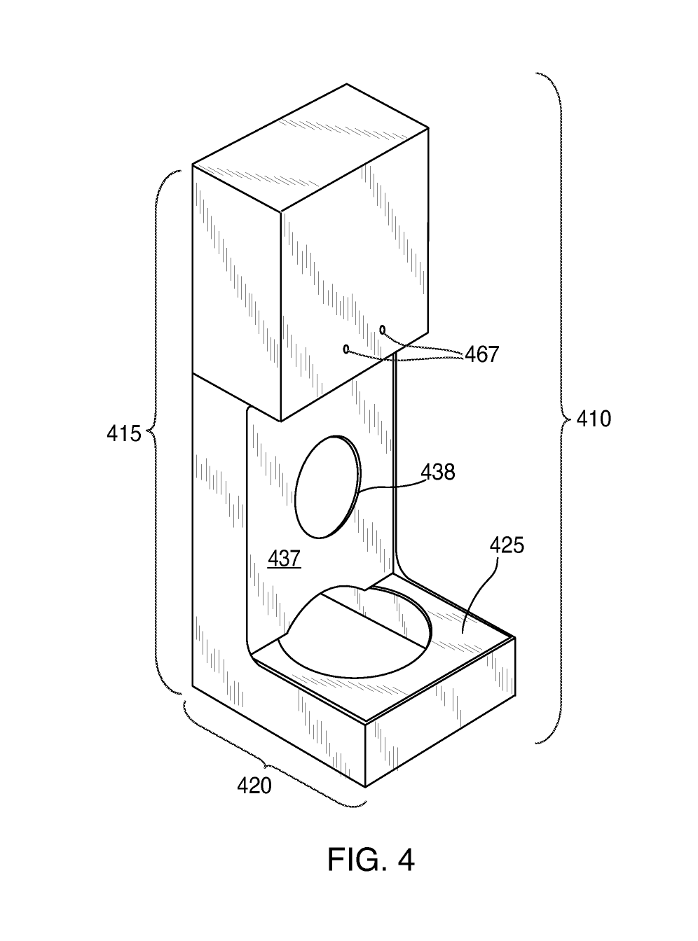

FIG. 4 illustrates a view of the shell of FIG. 1 with the lamp removed to show detail of the shell 410, the backplane support 437, and the base support 425. The shell 410 includes a base receptacle 420 a support column 415. The backplane support includes a set of apertures 467 and a cutout 438.

The base support 425 is positioned in base receptacle 420, of the shell 410. The backplane support 437 extends from the top of the base support 425 into the upper section of the support column 415, and forms the front wall of the support column where it is cut away. The backplane may have a cutout 438 for accommodating lamp shafts that protrude into the support column 415. The dimensions of the cutout 438 are determined by the intended product. The backplane 437 has at least one set of apertures 467 to allow for the retention strap, such as 165 of FIG. 1, to penetrate to secure the lamp to the shell 410.

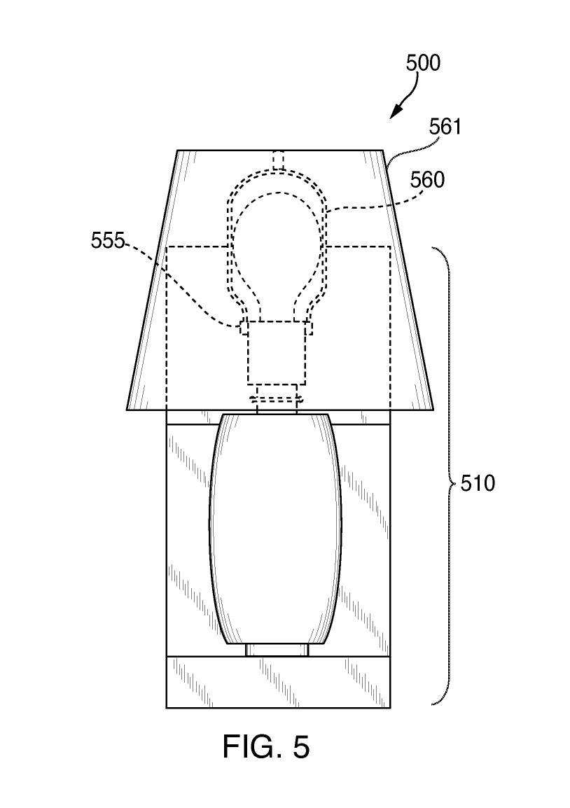

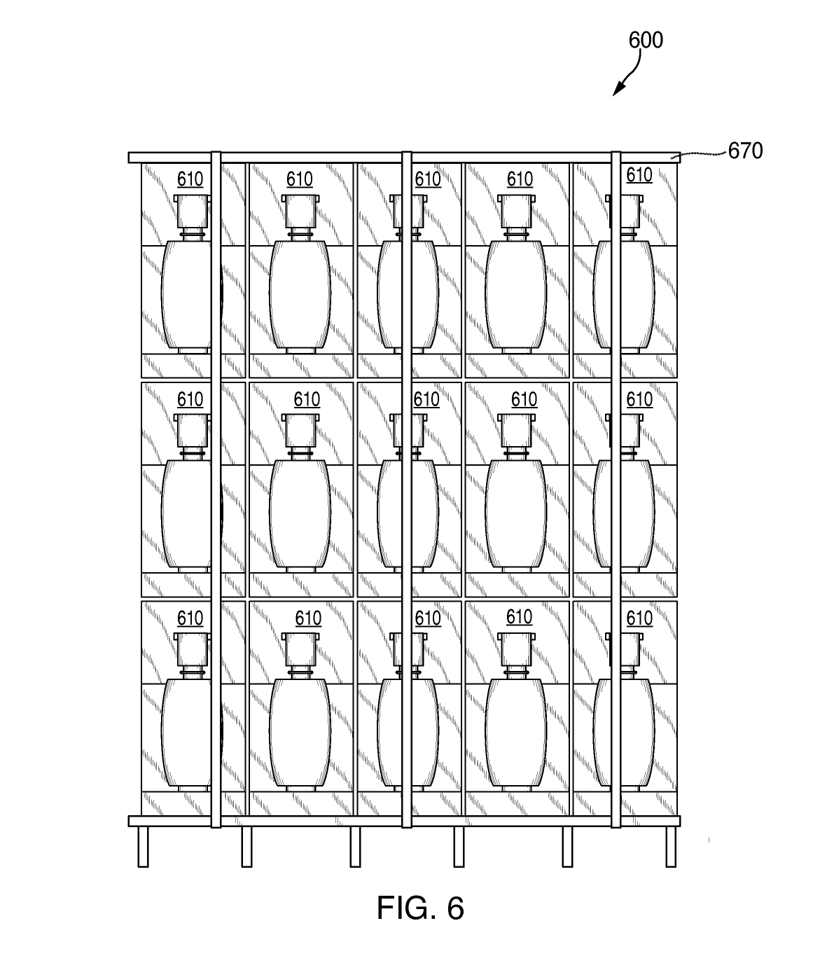

FIG. 5 illustrates an embodiment of a lamp packaging, shipping, and displaying device 500 with a lamp shade 561 and shade harp 560 installed on a lamp 530. The lamp harp is installed in the lamp harp receiver 555. The dimensions of the shell 510 allow for the lamp shade 560 to be installed over the shell.

In another embodiment a display bulb may be used for clip type lamp shades. The bulb is inserted into the light bulb socket and the lamp shade clips onto the bulb. The dimensions of the shell 510 allow for the lamp shade 561 to be installed over the shell.

FIG. 6 illustrates multiple lamp packaging, shipping, and displaying devices 600 and a packing flat to show the structural function of the device for shipping, storage, and display. The packing, shipping and display devices 610 are lined up front to back and side to side. A packing flat 670 is placed on top of the packing, shipping and display devices 610. The packing flat may be a flat piece of cardboard, plastic or the base of a box. The packing, shipping and display devices 610 may be with in a box or displayed removed from the box. The packing, shipping and display devices 610 form a series of supporting member for the next level of material. This allows for stacking of products for shipping, storage or display without deformation or failure of the packing, shipping and display devices 610.

The prior art failed to achieve a balance between structural support necessary for efficient shipment, storage, and display of the lamps and visibility of the lamp. If support is the driving factor, the result was cartons that encompass the entire lamp with a viewing hole or cartons that a substantial portion of lamp is within the carton and thus obscured from view. This gives the potential purchaser a very limited view of the product. If the viewablity was the driving factor then an open face box or diagonal cut box may be used, both offer increased viewablity, but are limited in that the side walls obscure the view of the lamp and more importantly the three wall design provides limited support for shipping, storage, and display commonly resulting in deformation and destruction of the carton. The result of both designs is to get a true view of the lamp it must be removed from the carton, which may be difficult due to retention elements and even more difficult to replace potentially lowering the display value of the carton.

In embodiments of the present invention the support column is located behind the lamp, only rear protrusion would be encompassed by the carton. The lamp is fully viewable from the front and sides, allowing the customer to get a true view of the lamp.

In embodiments of the prior art the lamp is enclosed in the carton and due to space considerations is normally not displayed with a lamp shade. Pictures on the box or foldable facsimiles have been used to convey to potential purchasers what the lamp would look like with a lamp shade. This fails to provide the potential customer with the look and feel of the complete product, and may be limited to a generic shade for display purposes.

In embodiments of the present invention the top of the lamp is unobstructed, and the dimensions of the carton are made sufficient for support, but allow for the installation of a lamp shade without removing the lamp from the carton. The display location can use a display bulb or shade harp to allow the customer to place various shades on the lamp to determine what shade and lamp design meet their individual needs.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A lamp packaging device including:
a shell for receiving at least one said lamp, wherein the shell includes a base receptacle and a support column, wherein said shell dimensions are proportioned to allow for the installation of a lamp shade on said lamp without removing said lamp from said shell;
a base support removably positioned within said base receptacle; and
a backplane support removably positioned within said support column.

2. The lamp packaging device of claim 1 wherein said support column is disposed substantially behind the lamp shaft of said lamp.

3. The lamp packaging device of claim 1 wherein said shell, base support, and backplane include cardboard or any other light weight reasonably stiff material which will conform and retain shape, without collapsing, when said material is scored, perforated or otherwise locally weakened for the purposes of folding the material into shape.

4. The lamp packaging device of claim 1 further including an upper and lower support within said support column.

5. The lamp packaging device of claim 1 wherein said backplane has a cutout to receive protrusions of a lamp shaft.

6. The lamp packaging device of claim 1 wherein the base support includes a recessed area for engaging the base of said lamp in a non-slip manner

7. The lamp packaging device of claim 4 wherein said upper and lower supports retain a shade harp.

8. The lamp packaging device of claim 1, wherein said shell is comprised essentially of flexi-stiff material.

9. A method for displaying lamps including:
Placing said lamp in a lamp packaging device, wherein said lamp packaging device includes;
a shell for receiving at least one said lamp, wherein the shell includes a base receptacle and a support column, wherein said shell dimensions are proportioned to allow for the installation of a lamp shade on said lamp without removing said lamp from said shell;
a base support removable positioned within said base receptacle; and
a backplane support removable positioned within said support column;
installing a shade harp on said lamp;
installing said lamp shade on said shade harp.

10. A method for displaying lamps including:
Placing said lamp in a lamp packaging device, wherein said lamp packaging device includes;
a shell for receiving at least one said lamp, wherein the shell includes a base receptacle and a support column, wherein said shell dimensions are proportioned to allow for the installation of a lamp shade on said lamp without removing said lamp from said shell;
a base support removable positioned within said base receptacle; and
a backplane support removable positioned within said support column;
installing a light bulb in said lamp;
installing said lamp shade on said shade harp.
